(19) United States
(12) Patent Application Publication
(10) Pub. No.: US 2021/0141661 A1
(43) Pub. Date: May 13, 2021

(54) Lightweight Context For CPU Idling Using A Real Time Kernel

(71) Applicant: Silicon Laboratories Inc., Austin, TX (US)

(72) Inventor: Jean-François Deschenes, Ste-Marthe-sur-le-Lac (CA)

(21) Appl. No.: 16/680,915

(22) Filed: Nov. 12, 2019

(51) Int. Cl. G06F 9/46; G06F 9/48; G06F 9/30

(52) U.S. Cl. CPC G06F 9/461; G06F 9/30083; G06F 9/30134; G06F 9/485

(57) ABSTRACT

A system and method of minimizing the context saved when the processing unit is disclosed. The kernel attempts to save time and memory by reducing or eliminating the amount of context that is saved or restored in certain situations. Specifically, if there is no currently executing, the kernel does not save any context before switching to another task. Similarly, if there is no new task to execute, the kernel does not restore any context before making the context switch. Rather, the kernel applies a lightweight context. In some embodiments, the idle context uses the ISR stack rather than having a dedicated stack. This system and method reduces the time required for certain context switches and also saves memory.

### FIELD

This disclosure describes systems and methods for reduced context switching when entering and exiting an idle state in a real time kernel.

### BACKGROUND

Operating systems typically utilize a scheduler or kernel that switches between tasks that are ready to execute. In certain embodiments, the operating system may be a pre-emptive system, which allows the operating system to interrupt an executing task when a higher priority task becomes ready.

When a new task is to be executed, the context of the previous task is stored in that task's stack. The context may include the contents of all processing unit registers, the program counter, and optionally hardware registers. Thus, if the kernel supports N tasks, there must be sufficient memory to save the context for all N tasks.

Once the context for the previous task has been saved, the context for the task to be executed is then restored from its stack. Once restored, the new task executes.

Thus, the time required by a context switch includes the time to save all of the context of one task and restore the context of a new task. The total time required for a context switch depends on the amount of context that is needed and the speed of the processing unit.

Further, in most operating systems, there is an idle task. This task has the lowest priority and executes only when there are no other tasks that are ready to execute. When another task is ready to execute, the context associated with the idle task is saved and the context for the new task is restored.

Thus, the transition from the idle task to another task is identical to any other context switch, where context must be saved before the context switch can be made. As stated above, this costs memory space and as well as additional time.

Therefore, it would be beneficial if there were a system and method that minimized the time and memory space required to switch from the idle task to another task.

### SUMMARY

A system and method of minimizing the context saved when the processing unit is executing an idle context is disclosed. The kernel attempts to save time and memory by reducing or eliminating the amount of context that is saved or restored in certain situations. Specifically, if there is no task currently executing, the kernel does not save any context before switching to another task. Similarly, if there is no new task to execute, the kernel does not restore any context before making the context switch. Rather, the kernel applies a lightweight context. In some embodiments, the idle context uses the ISR stack rather than having a dedicated stack. This system and method reduces the time required for certain context switches and also saves memory.

According to one embodiment, a method to minimize time consumed for context switches in a multi-task software environment is disclosed, where the method is executed by a kernel executing on a processing unit. The method comprises assigning each task in the multi-task software environment a state, where the state is indicative of the ability of the task to be executed and tasks that are ready to be executed are in a ready state; determining that a context switch is to be initiated; determining if there is a task currently being executed by the processing unit, referred to as a current task; if there is a current task, executing a save context routine to store all context associated with the current task in a first memory region; determining if there are any tasks in the ready state; if there is at least one task in the ready state, selecting one of the at least one tasks to execute, referred to as a next task; and executing a restore context routine to restore all context associated with the next task from a second memory region; and if there is no task in the ready state, applying an idle context. In certain embodiments, applying an idle context comprises loading an address in memory of an idle context handler in the processing unit. In certain embodiments, the idle context handler places the processing unit in a low power state. In certain embodiments, each task comprises an associated region of memory referred to as a task control block, where context and other information is stored, and the idle context handler does not have a task control block. In some embodiments, the idle context handler uses an interrupt service routine (ISR) stack to store any associated information. In some embodiments, if there is no current task, the kernel does not store any context prior to restoring context for the next task.

In another embodiment, a software program, comprising instructions disposed on a non-transitory storage media is disclosed. The software program, when executed by a processing unit, enables the processing unit to assign each task in a multi-task software environment a state, where the state is indicative of the ability of the task to be executed and tasks that are ready to be executed are in a ready state; determine that a context switch is to be initiated; determine if there is a task currently being executed by the processing unit, referred to as a current task; if there is a current task, execute a save context routine to store all context associated with the current task in a first memory region; determine if there are any tasks in the ready state; if there is at least one task in the ready state, select one of the at least one tasks to execute, referred to as a next task; and execute a restore context routine to restore all context associated with the next task from a second memory region; and if there is no task in the ready state, apply an idle context.

In another embodiment, a low power device is disclosed. The low power device comprises a processing unit; and a memory device, comprising instructions, which when executed by the processing unit, enable the processing unit to assign each task in a multi-task software environment a state, where the state is indicative of the ability of the task to be executed and tasks that are ready to be executed are in a ready state; determine that a context switch is to be initiated; determine if there is a task currently being executed by the processing unit, referred to as a current task; if there is a current task, execute a save context routine to store all context associated with the current task in a first memory region; determine if there are any tasks in the ready state; if there is at least one task in the ready state, select one of the at least one tasks to execute, referred to as a next task; and execute a restore context routine to restore all context associated with the next task from a second memory region; and if there is no task in the ready state, apply an idle context.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of the low power device;

FIG. 2 shows the relationship between the kernel, the tasks and the processing unit;

FIG. 3 shows the transitions for a task between the various states; and

FIG. 4 shows a flowchart illustrating a context switch according to one embodiment.

### DETAILED DESCRIPTION

FIG. 1 shows a block diagram of a representative low power device. Throughout this disclosure, the term “low power device” is used to refer to any device that utilizes a real time operating system and has limited power consumption. In certain embodiments, the device may be a network device, supporting one or more network protocols, such as WIFI, ZIGBEE®, Thread, Bluetooth®, and Bluetooth Low Energy (BLE). In these embodiments, the device may be an IoT device.

FIG. 1 shows a block diagram of a representative device 20. The device 20 has a processing unit 21 and an associated memory device 22. This memory device 22 contains the instructions, which, when executed by the processing unit, enable the device 20 to perform the functions described herein. This memory device 22 may be a non-volatile memory, such as a FLASH ROM, an electrically erasable ROM or other suitable devices. In other embodiments, the memory device 22 may be a volatile memory, such as a RAM or DRAM. In all embodiments, the memory device 22 is a non-transitory storage medium.

The device may also include a network interface 23, which is a wireless interface that includes an antenna 25. Additionally, the network interface comprises a radio 24, which may include the baseband processing and lower MAC level processing. The device 20 may include a second memory device 26 in which data that is received by the network interface 23, and data that is to be transmitted by the network interface 23, is stored. This second memory device 26 is traditionally a volatile memory. The processing unit 21 has the ability to read and write the second memory device 26 so as to communicate with the other nodes in the network. Although not shown, each device 20 also has a power supply, which may be a battery or a connection to a permanent power source, such as a wall outlet.

The software environment may be a multi-task software environment, where there are a plurality of tasks, each competing to use the same processing unit 21. In certain embodiments, the software environment may be a real-time environment, where tasks need to executed within defined windows of time. Additionally, the software environment may also include interrupt handlers, which are executed in real-time in response to the associated interrupts.

The kernel 40 resides at the lowest layer in the software program. Specifically, the kernel, among other responsibilities, is used to select the task that will be executed by the processing unit 21.

FIG. 2 shows the architecture of the software in the device 20. Within the device 20, there are a plurality of tasks that may be executed. These tasks may be in one of a plurality of different states.

At the lowest level is the hardware, and more specifically, the processing unit 21. The kernel 40 is disposed between the hardware and the various tasks that are to be executed by the processing unit 21.

These tasks may be in one of three queues or states. There is a waiting queue 50, which are the tasks that are waiting for some event before being ready to execute. There is also a ready queue 60, which are tasks that are ready to execute. Finally, there is an executing queue 70, which is the one task that is currently being executed by the processing unit 21.

FIG. 3 shows how the kernel 40 transitions a task between these various states.

A task may have an associated task control block (TCB). The TCB may be a region in memory that is associated with the particular task. The TCB may include an area to be used as the stack for this task. The TCB may also have a region for local variable storage. It may also include other information, such as the priority of the task.

A task may be in the Waiting state 100. In the Waiting state, the task is waiting for an event to occur. This event may be an interrupt, such as a key press, receipt of a network packet, or another activity. Alternatively, the event may be the expiration of a timer. For example, a certain task may execute periodically, such as every 10 milliseconds. After it completes, the task enters the Waiting state 100 waiting for the expiration of the timer.

From the Waiting state 100, the task may enter the Ready state 110. All tasks in the Ready state are ready to be executed. In other words, they are not waiting on any event. The kernel 40 selects one of the tasks in the Ready state 110 to execute and that task moves to the Executing state 120. The kernel 40 may utilize a variety of different algorithms to determine which task is to be executed. In certain embodiments, each task has a priority, where that priority indicates the criticality of the task's start time. For example, a first task may be used to display some visual indication after a key press. Because of the speed of human recognition, a response of 100 millisecond or less may be acceptable. A second task may be required to response to a network packet. The network protocol may require a response in less than 10 milliseconds. Thus, in this example, the second task is given a higher priority than the first task to ensure that it is able to execute within the required window.

Once moved to the Executing state 120, a task may utilize the processing unit and any other resources. The task may remain in the Executing state until one of one the following conditions occurs:
Preemption;
Termination;
Blocked; and
An interrupt.

Preemption refers to the condition where a higher priority task has just moved to the Ready state 110. When this occurs, the task in the Executing state 120 is moved back to the Ready state 110 and the higher priority task is moved to the Executing state 120.

Termination refers to the condition where the task has completed its function. For example, a task may be responsible for responding to a network packet. Once the response has been sent, the task has completed its function. In this case, the task moves to the Waiting state 100, waiting for the next network packet to arrive.

Blocked refers to the condition where the task cannot execute because it is waiting for a particular resource to become available. In this case, the task moves to the Waiting state 100, waiting for the resource to become available.

Interrupt refers to the presence of an interrupt, which requires the kernel 40 to execute an interrupt service routine (ISR) 130. In the event of an interrupt, the task is suspended while the kernel 40 executes the ISR. Once the ISR completes, the kernel 40 then returns to the task that is currently in the Executing state 120. Note that the interrupt may represent an event that moves a different task from the Waiting state 100 to the Ready State 110.

The transition from the Executing state 120 requires a context switch. Specifically, the task that is transitioning from the Executing state 120 must have all context saved in its stack. As described above, this includes the program counter, the contents of the processing unit's registers, and any other hardware registers. After the task's context has been saved, it can transition to the Ready state 110 or the Waiting state 100, depending on the reason for its transition.

Similarly, the task that the kernel 40 has selected to move to the Executing state 120 must have its context restored. This involved copying information from the task's stack into the processing unit's registers and any other hardware registers. After this is complete, the new task may begin executing.

As stated above, in most embodiments, there is always at least one task in the Ready state 110. Many real time operating systems utilize an “idle task”, which typically serves to put the processing unit in a lower power state, waiting for an event or an interrupt that transitions another task to the Ready state 110.

In certain embodiments, the real time operating system utilizes one or more routines to perform the context switch. For example, a first routine, or save_context routine, may be used to save_context when a task exits the Executing state 120. That save_context routine may be passed a parameter, that represents the identity of the executing task. For example, in one embodiment, that parameter may be a pointer to the TCB of the executing task, referred to as Current_Task_Ptr. Using this parameter, the save_context routine may determine the address in memory device 22 where the stack for this task is located. The save_context routine then stores all of the data from the processing unit's registers into the stack located at that address in memory device 22.

Similarly, a second routine, or restore_context routine, may be used to restore the context of another task that is being moved to the Executing state 120. That restore context routine may be passed a parameter that represents the identity of the new task. For example, the parameter may be a pointer to the TCB of the new task referred to as Next_Task_Ptr. Using this parameter, the restore_context routine may determine the address in memory device 22 where the stack for this task is located. The restore_context routine then loads all of the data from stack located at that address into the processing unit's registers.

In the present disclosure, there is no defined idle task. This eliminates the need to save and restore context when switching to or from the idle condition. Further, the elimination of the idle task may also free memory as there is no longer a TCB associated with an idle task.

A flowchart of this embodiment is shown in FIG. 4. First, unlike the prior art, there is no longer a guarantee that there is at least one task in the ready queue 60. Specifically, without an idle task, it is possible that there are no tasks in the Ready state 110. Similarly, it is also now possible that there is no task in the executing queue 70.

The parameters identified above, Current_Task_Ptr and Next_Task_Ptr, may be used to determine if either of these conditions exists. Specifically, if there is no task currently executing, the parameter, Current_Task_Ptr, may be set to 0. Similarly, if there are no tasks in the ready queue 60, the parameter, Next_Task_Ptr, may be set to 0.

Assume that the task that is currently executed becomes blocked and there are no other tasks in the ready queue 60. In this case, the kernel 40 will determine that there is no task that can be executed. Upon making this determination, the kernel 40 may be set a special flag. In another embodiment, the kernel may indicate that the address of the next task, Next_Task_Ptr, is “0”, an indication that there is no task. Thus, in this case, once the context switch is completed, there is no task to be executed.

As shown in FIG. 4, when there is a higher priority task in the ready queue 60 or the currently executing task becomes blocked or terminates, a context switch is initiated, as shown in Process 400. As the context switch function begins, the kernel 40 checks to see whether there is currently a task that is executing, as shown in Process 410. As stated above, this may be determined using a special flag or by using a special value in the parameter used to identify the currently executing task. In one embodiment, as described above, there is a pointer to the TCB of the executing task (Current_Task_Ptr). If this pointer is set to 0, it is indicative that there is no currently executing task. Other techniques may be used to determine whether there is a currently executing task.

If there is a currently executing task, the kernel 40 executes the save_context routine, as shown in Process 420.

If, however, there is no currently executing task is the idle task, the kernel 40 may simply skip this routine.

Next, the context for the new task must be restored. Again, the kernel 40 checks if there is a new task to be executed, as shown in Process 430. This may be done by comparing the parameter associated with the new task, Next_Task_Ptr, to a specific value. Of course, other techniques may be used to determine whether this is a new task to execute.

If there is new task, the kernel 40 executes the restore-context routine, as shown in Process 440.

If, however, there is no new task, the kernel 40 simply applies an idle context and may use the Interrupt Service Routine (ISR) stack, as shown in Process 450. Specifically, the kernel 40 applies a constant and lightweight context which is always the same. This constant and lightweight context is referred to as the idle context. As an example, in Process 450, the kernel 40 may load a predetermined address into the program counter of the processing unit 21. This predetermined address may be a location in memory device 22 and may be the address of an idle context handler. The idle context handler is the code that is executed when there are no tasks to execute. In certain embodiments, the idle context handler may put the processing unit 21 in a low power state or perform some other function. This address may be determined at the time of compilation and may be a pointer to the idle context handler. As stated above, in certain embodiments, the kernel 40 loads this value into the program counter. In other embodiments, the instructions executed during Process 450 include a “Jump” to this idle context handler. In all embodiments, the result is that the processing unit 21 executes the idle context handler.

In certain embodiments, the kernel 40 may optionally load one or more registers of the processing unit 21. The kernel 40 may also change the stack pointer used by the CPU to the ISR stack in certain embodiments. Since the idle context is only invoked when there are no tasks or interrupt service routines executing, the address loaded into the stack pointer may be an absolute address.

However, note that no context is saved when this idle context is later replaced by a higher priority task. Therefore, whenever the idle context is invoked, it restarts execution from the same predetermined location in the memory device 22.

Additionally, in certain embodiments, additional memory may be saved by using the ISR stack to store any local variables associated with the idle context handler. Therefore, unlike tasks, which include Task Control Blocks (TCBs) and predetermined areas in memory for their stacks, there is no memory that is dedicated to the idle context, except for the memory needed to store the instructions for the idle context handler. In other embodiments, a region in memory device 22 may be reserved for the idle context handler.

Thus, in one embodiment, the present disclosure describes a method to minimize context switch time in a multi-task software environment. Further, in another embodiment, the present disclosure describes a device 20. The device 20 has an operating system, or kernel 40, that executes on the processing unit 21 in the device 20. The kernel 40 is able to select among a plurality of tasks to execute. These tasks may be in one of a plurality of states, including a Waiting state, a Ready State and an Executing state. If, at the time of a context switch, there are no tasks in the Ready state, the kernel 40 does not restore any context. Rather, it simply applies an idle context. Similarly, if there was no task that was previously executing, the kernel 40 does not save any context.

In another embodiment, the present disclosure describes a software program, referred to as a kernel 40. This software program may be stored in the memory device 22 and executed by the processing unit 21. In terms of data flow, this kernel 40 is disposed between tasks that are to be executed and a hardware component, such as the processing unit 21. In this embodiment, an idle task is not created. In one embodiment, the kernel 40 seeks to minimize the time required for a context switch when there is no task that is being executed. Further, when the currently executing task finishes or becomes blocked and there is no task in the ready queue 60, the kernel 40 may apply a lightweight context to the processing unit 21. This idle context may be a pointer to an idle context handler, which is a routine located in memory that is executed by the processing unit 21 when there are no other tasks to execute. As described above, in some embodiments, the idle context handler transitions the processing unit 21 to a lower power state, where it awaits an interrupt.

The present system and method have many advantages. For example, in the case where there is no currently executing task, the time for a save and restore context during a context switch may be reduced roughly in half. Similarly, in the case where there is no task in the ready state, the time for a context switch is likewise reduced. Additionally, since there is no idle task, less memory is need, as a TCB is no longer needed for an idle task.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method to minimize time consumed for context switches in a multi-task software environment, the method executed by a kernel executing on a processing unit, the method comprising:
assigning each task in the multi-task software environment a state, where the state is indicative of an ability of the task to be executed and tasks that are ready to be executed are in a ready state;
determining that a context switch is to be initiated;
determining if there is a task currently being executed by the processing unit, referred to as a current task;
if there is a current task, executing a save context routine to store all context associated with the current task in a first memory region;
determining if there are any tasks in the ready state;
if there is at least one task in the ready state, selecting one of the at least one task to execute, referred to as a next task; and
executing a restore context routine to restore all context associated with the next task from a second memory region;
and
if there is no task in the ready state, applying an idle context.

2. The method of claim 1, wherein applying an idle context comprises loading an address of an idle context handler in the processing unit.

3. The method of claim 2, wherein the idle context handler places the processing unit in a low power state.

4. The method of claim 2, wherein each task comprises an associated region of memory referred to as a task control block, where context and other information is stored, and wherein the idle context handler does not have a task control block.

5. The method of claim 4, wherein the idle context handler uses an ISR stack to store any associated information.

6. The method of claim 5, wherein the idle context loads an absolute address into an interrupt service routine (ISR) stack pointer.

7. The method of claim 1, wherein if there is no current task, the kernel does not store any context prior to restoring context for the next task.

8. A software program, comprising instructions disposed on a non-transitory storage media, which when executed by a processing unit, enable the processing unit to:
assign each task in a multi-task software environment a state, where the state is indicative of an ability of the task to be executed and tasks that are ready to be executed are in a ready state;
determine that a context switch is to be initiated;
determine if there is a task currently being executed by the processing unit, referred to as a current task;
if there is a current task, execute a save context routine to store all context associated with the current task in a first memory region;
determine if there are any tasks in the ready state;
if there is at least one task in the ready state, select one of the at least one task to execute, referred to as a next task; and
execute a restore context routine to restore all context associated with the next task from a second memory region; and
if there is no task in the ready state, apply an idle context.

9. The software program of claim 8, wherein applying an idle context comprises loading an address of an idle context handler in the processing unit.

10. The software program of claim 9, wherein the idle context handler places the processing unit in a low power state.

11. The software program of claim 9, wherein each task comprises an associated region of memory referred to as a task control block, where context and other information is stored, and wherein the idle context handler does not have a task control block.

12. The software program of claim 11, wherein the idle context handler uses an ISR stack to store any associated information.

13. The software program of claim 12, wherein the idle context loads an absolute address into an ISR stack pointer.

14. The software program of claim 8, wherein if there is no current task, no context is stored prior to restoring context for the next task.

15. A low power device, comprising:
a processing unit; and
a memory device, comprising instructions, which when executed by the processing unit, enable the processing unit to:
assign each task in a multi-task software environment a state, where the state is indicative of an ability of the task to be executed and tasks that are ready to be executed are in a ready state;
determine that a context switch is to be initiated;
determine if there is a task currently being executed by the processing unit, referred to as a current task;
if there is a current task, execute a save context routine to store all context associated with the current task in a first memory region;
determine if there are any tasks in the ready state;
if there is at least one task in the ready state, select one of the at least one task to execute, referred to as a next task; and
execute a restore context routine to restore all context associated with the next task from a second memory region; and
if there is no task in the ready state, apply an idle context.

16. The low power device of claim 15, wherein applying an idle context comprises loading an address of an idle context handler in the processing unit.

17. The low power device of claim 16, wherein the idle context handler places the processing unit in a low power state.

18. The low power device of claim 16, wherein each task comprises an associated region of memory referred to as a task control block, where context and other information is stored, and wherein the idle context handler does not have a task control block.

19. The low power device of claim 18, wherein the idle context handler uses an ISR stack to store any associated information.

20. The low power device of claim 19, wherein the idle context loads an absolute address into an ISR stack pointer.
